(19) United States
(12) Patent Application Publication
(10) Pub. No.: US 2009/0056541 A1
(43) Pub. Date: Mar. 5, 2009

(54) Method and apparatus for high resolution flash chromatography

(76) Inventors: Dale A. Davison, Greenwood, NE (US); Ruth Pipes, Odell, NE (US); Jack E. Silver, Lincoln, NE (US)

Correspondence Address: VINCENT L. CARNEY LAW OFFICE, P.O. BOX 80836, LINCOLN, NE, 68501-0836, US

(21) Appl. No.: 12/228,725

(22) Filed: Aug. 15, 2008

Related U.S. Application Data
(63) Continuation-in-part of application No. 11/171,698, filed on Jun. 30, 2005.
Application No. 11/171,698 is a continuation-in-part of application No. 10/697,496, filed on Oct. 30, 2003, now Pat. No. 7,008,541.
Application No. 10/697,496 is a continuation-in-part of application No. 10/389,626, filed on Mar. 14, 2003, now Pat. No. 6,949,194.
Application No. 10/389,626 is a division of application No. 09/920,124, filed on Aug. 1, 2001, now Pat. No. 6,565,745.

(51) Int. Cl. B01D 53/02; B01D 15/08; C07F 7/02

(52) U.S. Cl. 95/88; 210/198.2; 556/443

(57) ABSTRACT

To make an inexpensive chromatographic column and perform chromatography with it, column walls and a column end with a port are molded integrally from plastic. A closure is integrally molded with a port as well. One type of closure includes part of a snap-on fastener integrally molded to it to cooperate with corresponding parts molded integrally with the column walls. In another type of closure for higher pressures, the closure is spin welded to the tubular walls. In still another type of closure for still higher pressures, a retaining plate is pressed into the column to hold the packing in place. The closures have channels molded into them radiating from a port and opening toward packing material such as silica beads or porous polymeric plugs. Filters and secondary seals may be located at the ends to prevent leakage of the packing material. The packing is balanced spherical or spheroid-like derivitized silica packing.

### REFERENCE TO RELATED APPLICATIONS

This application is a continuation-in-part of U.S. application Ser. No. 11/171,698, filed Jun. 30, 2005, entitled DISPOSABLE CHROMATOGRAPHIC COLUMNS which is a continuation-in-part application of U.S. application Ser. No. 10/697,496 filed Oct. 30, 2003, entitled DISPOSABLE CHROMATOGRAPHIC COLUMNS, now U.S. Pat. No. 7,008,541, which is a continuation-in-part application of U.S. application Ser. No. 10/389,626 filed Mar. 14, 2003, entitled DISPOSABLE CHROMATOGRAPHIC COLUMNS, now U.S. Pat. No. 6,949,194, which is a divisional application of U.S. application Ser. No. 09/920,124 filed Aug. 1, 2001, entitled DISPOSABLE CHROMATOGRAPHIC COLUMNS, now U.S. Pat. No. 6,565,745.

### BACKGROUND OF THE INVENTION

This invention relates to high resolution flash chromatography.

It is known to use flash chromatography as an inexpensive technique for preparatory chromatography. Flash chromatography operates at low pressure with particles that are relatively large in size such as 40 to 60 microns, and may be irregular and thus not as compact and uniform in packing. A 1978 publication Still, et al., Rapid Chromatographic Technique for Preparative Separations with Moderate Resolution, J. Org. Chem., Vol. 43, No. 14, 1978, pg. 2923-2930, second and third paragraphs, teaches the use of a wide range of silica gel sizes with irregular shapes and comments specifically on silica gel 60 stating that 63-200 micron silica particles gave the poorest results and particles under 40 microns were no better. Generally, flash chromatography is limited in its application because of its relatively low resolution.

For higher resolution, HPLC has been used but it has a higher cost because the equipment is more elaborate. It uses higher pressure, smaller particles such as 10 to 20 microns for preparatory HPLC, and may include more compact and uniform packing such as spheres and spheroid-like particles.

It is known to improve the resolution of liquid chromatography through the use of spherical packing material from U.S. Pat. No. 6,257,942. In one prior art reference, United States published application 2005/0287062, flash chromatographic columns are taught having spherical and porous silica gel with granules comprised between 3 and 45 microns and pores comprised between 30 and 300 Angstrom units. Spherical silica packing was available at least by 1999, as shown by U.S. Pat. No. 6,267,942. The publication Watanabe, et al, Structure of a New Glycobacterium Avium-Mycobacterium Intracelluare Complex; Journal of Bacteriology, Vol. 181, No. 7, April, 1999, gh 2293-2297 describes the use of spherical packing 200/350 mesh in chromatographic separations.

It is known from U.S. Pat. No. 6,800,777 to use silica particles with alkyls or other coatings as packing for flash chromatography. The coats provide characteristics such as low polarity beneficial in reversed phase liquid chromatography. The addition of such coats and the use of the packing may change the conditions of use such as by requiring different solvents or by increasing back pressure. Thus, the derivitization of the silica particles may have disadvantages such as requiring that more expensive HPLC be used rather than the less expensive flash chromatography or reducing resolution.

It is also known to use disposable chromatographic columns intended for limited use and accordingly manufactured with economy in mind. Generally, this type of column is manufactured of inexpensive plastics and designed to be easily assembled by filling the body of the column with the desired packing with frit plugs on each end of the packing to hold the packing in place and then fastening the open end or ends to the body of the column. In some columns, the packing is held under pressure to reduce its tendency to shift and separate since the shifting and separation tends to create nonuniformity and loose particles of packing. The lack of uniformity in the packing promotes peak spreading of the eluant.

### SUMMARY OF THE INVENTION

Accordingly, it is an object of the invention to provide a novel method and apparatus for performing liquid chromatography.

It is a further object of the invention to provide a novel method and apparatus for improving the resolution of flash chromatography.

It is a still further object of the invention to provide a novel liquid chromatographic column.

It is a still further object of the invention to provide a novel packing for liquid chromatographic columns used in flash chromatography.

It is a further object of the invention to provide a novel method of manufacturing and using a chromatographic column.

It is a still further object of the invention to provide a novel inexpensive disposable chromatographic column.

It is a still further object of the invention to provide an inexpensive flash chromatographic column that performs well under higher pressure than prior art flash chromatographic columns.

It is a still further object of the invention to provide an inexpensive chromatographic column with more than two retaining plates.

In accordance with the above and further objects of the invention, derivitized spherical and spheroid-like silica particles with a surface that alters the adsorb-desorb characteristics of the particle are provided. The size and shape of the silica particles is chosen together with the derivitazation so that the particles have a reduced back pressure due to the size and shape of the particles that offsets the increased back pressure caused by the derivitization and use of the column that called for the derivitization sufficiently so that flash chromatography can be used for separations that would otherwise require HPLC.

In this specification, the word “derivitized” modifying words such as “silica particles”, or “packing” or “shape stabilized packing” means the surface of the particles or packing or shape stabilized packing has been modified to change their adsorb-desorb characteristics. For example, derivitized particles may have had chemical ligands bonded to the surface of the silica containing chemical groups that decrease the polar characteristics to provide better reverse phase chromatography. In the preferred embodiment, the diameters of the particles in a column fall within one of several narrow ranges of ten and twenty microns each. In the preferred embodiment, the columns are within the range of between ten and fifty microns and preferably between twenty and forty microns. Ligands are attached to the surface. In the preferred embodiment, the ligands have low polarity to permit reversed phase chromatography. Three such ligands are:

CAS: 3069-40-7 n-Octyl-trimethoxysilane Equation 1

CAS: 3069-42-9 n-Octadecyl-trimethoxysilane Equation 2

CAS: 71808-65-6 n-Octadecyl-dimethylmethoxysilane Equation 3

In making the packing, a molecule with a desired adsorption-desorption characteristic is reacted with the silica spheres and spheroid-like particles to form a silane bond connecting the ligand to the silica sphere or spheroid-like particle.

To maintain the low pressure and low cost of flash chromatography, an inexpensive disposable chromatographic column is formed of a relatively inexpensive material, and filled with the derivitized spherical or spheroid-like packing material. For some separations, such as those using larger diameter columns, one or more column adjusted retaining plates are pressed into the tubular body of the chromatographic column to hold a frit plug in place under pressure before the column is closed. The retaining plates are included to press the frit plugs against the packing material and hold it in place. This reduces the tendency for the packing to form gaps or discontinuities that promote peak spreading. Composite walls can reduce the problem but increase the cost of the column. The retaining plates are placed under compression as they are linearly forced into the column but extend outwardly as the column walls move outwardly under pressure during a chromatographic run and thus continue to grip the walls of the column, exert pressure on the packing material through the frit plugs and thus prevent packing material from shifting in position to create gaps. Moreover, additional plates can be used to increase the pressure rating further.

The retaining plates grip the inner walls of the chromatographic column's tubular body with sufficient tightness to prevent packing material from squeezing past them under the operating pressure of the column. For this purpose, they should have an effective modulus of elasticity sufficiently low to flex as they are pressed into the column by an amount greater than the difference between the diameter of the retaining plate and the inner diameter of the column after any increase in inner diameter of the column caused by the movement of the column outwardly under high pressure. They should also have a modulus of elasticity sufficiently high to grip the walls of the column with enough force: (1) to not be moved into a position that permits pressure to be released on the packing to such an extent as to permit the packing to move and create discontinuity; and (2) to prevent pressure to be passed to the welded cap to loosen it enough for leakage. The rupture strength and yield point of the material from which the retaining plate is made must be sufficient to withstand its bending without rupture and without taking a permanent set as it is pressed into the column.

In this specification, the term “effective modulus of elasticity” means the ratio of stress to strain of the entire retaining plate rather than only of the material from which it is composed so that it reflects the distance the retaining plate flexes inwardly under force as it is pressed into the column. Preferably, the effective modulus of elasticity is between 27×10⁶ and 32×10⁶ psi (pounds per square inch). Generally the retaining plates are within the range of thickness of 10 thousandths and 0.125 of an inch when suitable materials are used and should be less than ⅛ of an inch to maintain dead space at a minimum.

To make an inexpensive flash chromatographic column, a tubular body is molded from plastic, filled with spherical or spheroid-like derivitized granules and closed. Preferably, before closing, at least one column adjusted retaining plate is pressed into the tubular body to hold frits in place. The frits compress the spherical or spheroid-like granules. The packing, frits and retaining plates are selected to increase the pressure rating of the flash chromatographic column and thus permit a wider range of materials to be separated by flash chromatography. Pressure is applied to the at least one column adjusted retaining plate during the assembly of the column sufficient to form a design-pressure packing.

In performing flash chromatography, solvent is caused to flow from at least one source of solvent through an inlet port of a column. The solvent flows toward an interior of the column; causing the solvent to flow through frit, through the spherical or spheroid-like derivitized packing material in its path between the inlet port and the outlet port and through at least one column adjusted retaining plate. The column is disposed of after between one and ten chromatographic runs and a new column is connected.

### BRIEF DESCRIPTION OF THE DRAWINGS

The above noted and other features of the invention will be understood from the following detailed description when considered with reference to the accompanying drawings in which:

FIG. 1 is a flow diagram of a process for performing flash chromatography in accordance with an embodiment of the invention;

FIG. 2 is a flow diagram of a process for making columns in accordance with an embodiment of the invention;

FIG. 3 is an elevational side view partly broken away and sectioned of an embodiment of column in accordance with the invention;

FIG. 4 is an exploded perspective view of the column of FIG. 3;

FIG. 5 is a block diagram of a chromatographic system in accordance with an embodiment of the invention;

FIG. 6 is a block diagram of a process of assembling a column in accordance with an embodiment of the invention;

FIG. 7 is a block diagram of a process of using a column in accordance with an embodiment of the invention;

FIG. 8 is an exploded perspective view of another embodiment of a column in accordance with the invention;

FIG. 9 is a side elevational view, partly broken away and sectioned, of the embodiment of FIG. 8;

FIG. 10 is a plan view of an embodiment of a retaining plate in accordance with an embodiment of the invention; and

FIG. 11 is a side view of an embodiment of the retention plate of FIG. 10.

### DETAILED DESCRIPTION

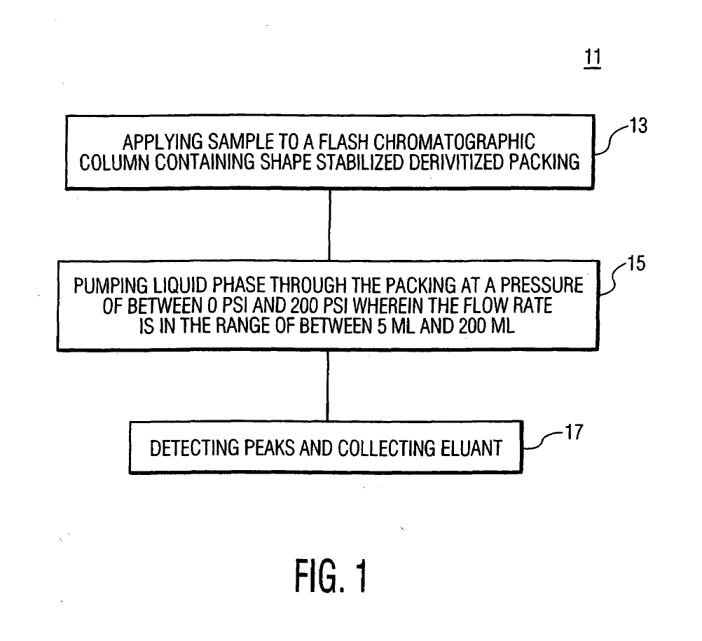

In FIG. 1, there is shown a block diagram 11 of a process for flash chromatography comprising the step 13 of applying sample to a flash chromatographic column containing shape stabilized derivitized packing; the step 15 of pumping liquid phase solvent through the packing at a pressure that is within the range of 0 and 200 psi wherein the flow rate is in the range of between 5 and 200 milliliters; and the step 17 of detecting peaks and collecting eluant.

In this specification, the words “shape stabilized” means particles, granules or packing material without shaped edges or thin portions that can be easily separated from the main body of the particle or granule of a shape that resists breaking to create fines. They are generally formed only of curved surfaces such as spheres or spheroid-like particles, granules or packing. In this specification, the word “derivitized” modifying words such as “silica particles” or “packing” or “shape stabilized packing” means the surface of the particles or packing or shape stabilized packing has been modified to change their adsorb-desorb characteristics. For example, derivitized particles may have had chemical ligands bonded to the surface of the silica containing chemical groups that decrease the polar characteristics to provide better reverse phase chromatography.

In the preferred embodiment, the packing is balanced. In this specification, the word “balanced” when applied to packing means that the size and shape of the particles, granules or packing is chosen together with the derivitazation so that the particles have a reduced back pressure due to the size and shape of the particles that offsets the increased back pressure caused by the changes in the mobile and stationary phases associated with the derivitization. The reduced back pressure due to the size and shape of the particles is sufficient so that flash chromatography can be used for separations that would otherwise require HPLC.

In the preferred embodiment, the diameters of the particles in a column fall within one of several narrow ranges of ten and twenty microns. All of the columns fall within a range of between ten and fifty microns and preferably twenty and forty microns. Ligands are attached to the surface. The ligands are less polar to permit reversed phase chromatography. Three such ligands are:

CAS: 3069-40-7 n-Octyl-trimethoxysilane Equation 1

CAS: 3069-42-9 n-Octadecyl-trimethoxysilane Equation 2

CAS: 71808-65-6 n-Octadecyl-dimethylmethoxysilane Equation 3

In making the packing, a molecule with a desired adsorption-desorption characteristic is reacted with the silica spheres and spheroid-like particles to form a silane bond connecting the ligand to the silica sphere or spheroid-like particle.

To maintain a low pressure and low cost of flash chromatography, an inexpensive disposable chromatographic column is formed of a relatively inexpensive material, and filled with the balanced derivitized spherical or spheroid-like shaped stabilized packing material. In some embodiments, one or more column adjusted retaining plates are pressed into the tubular body of the chromatographic column to hold frit plugs in place under pressure before the column is closed. For example, one or more column adjusted retaining plates may be pressed into the column. When two column adjusted retaining plates are used, a one of the two retaining plates presses on one end frit plug and the other retaining plate presses against the other plug.

In some embodiments, three or four column adjusted retaining plates are pressed into the column. Pressurizing the packing reduces the tendency for the packing to form gaps or discontinuities that promote peak spreading. Composite walls can reduce the problem but increase the cost of the column. Flexible retaining plates are placed under compression as they are linearly forced into the column but extend outwardly as the column walls move outwardly under pressure during a chromatographic run and thus continue to grip the walls of the column to hold the frit plugs in place and exert pressure on the packing material through the frit plugs. Moreover, additional plates can be used to increase the pressure rating still further.

In performing flash chromatography, solvent is caused to flow from at least one source of solvent through an inlet port of a column. The solvent flows toward an interior of the column; through frit, through the balanced, shape compensated derivitized packing material, between the inlet port and the outlet port and through at least one column adjusted retaining plate. The column is disposed of after between one and ten chromatographic runs and a new column is connected.

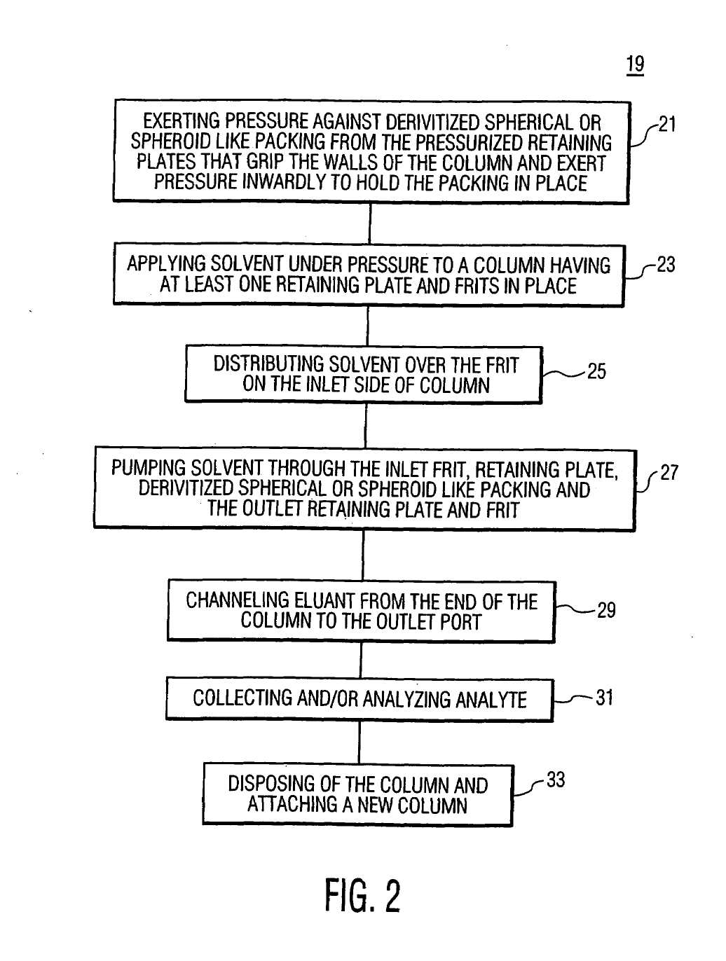

In FIG. 2, there is a flow diagram 19 showing the use of columns in accordance with an embodiment of the invention, including the step 21 of exerting pressure against the derivitized spherical or spheroid like packing from the pressurized retaining plates that grip the walls of the column and exert pressure inwardly to hold the packing in place, the step 23 of applying a solvent under pressure to a column with a retaining plate and frit plugs in place; the step 25 of distributing solvent over the frit plug at the inlet side of the column, the step 27 of pumping solvent through the inlet frit, retaining plate, derivitized spherical or spheroid-like packing and the outlet retaining plate and frit; the step 29 of channeling eluant from the end of the column to the outlet port; the step 31 of collecting and/or analyzing the analyte; and the step 33 of disposing of the column and attaching a new column.

In this process, an inexpensive column is used even though the pressure for performing the liquid chromatography is so high that the walls of the column may be forced outwardly from the frit plug and release pressure on the packing and permit some packing material to be moved and create gaps and in some cases, loosen the end plate of the column so that it leaks. In this embodiment, a retaining plate that is placed under compression when it is linearly inserted into the column expands as pressure is increased within the column by movement outward of the column walls and holds the frit in place to block passage of packing material around the edges of the frit plug. Preferably, the retaining plate is held between the outlet side of the frit plug and the bottom or end plate of the column so that it remains relatively stiff and under pressure. Because the retaining plate can be easily formed such as by molding of a plastic or machining of a stainless steel thin member and can be pressed into the column with only linear force, the column may remain inexpensive and yet handle high pressures.

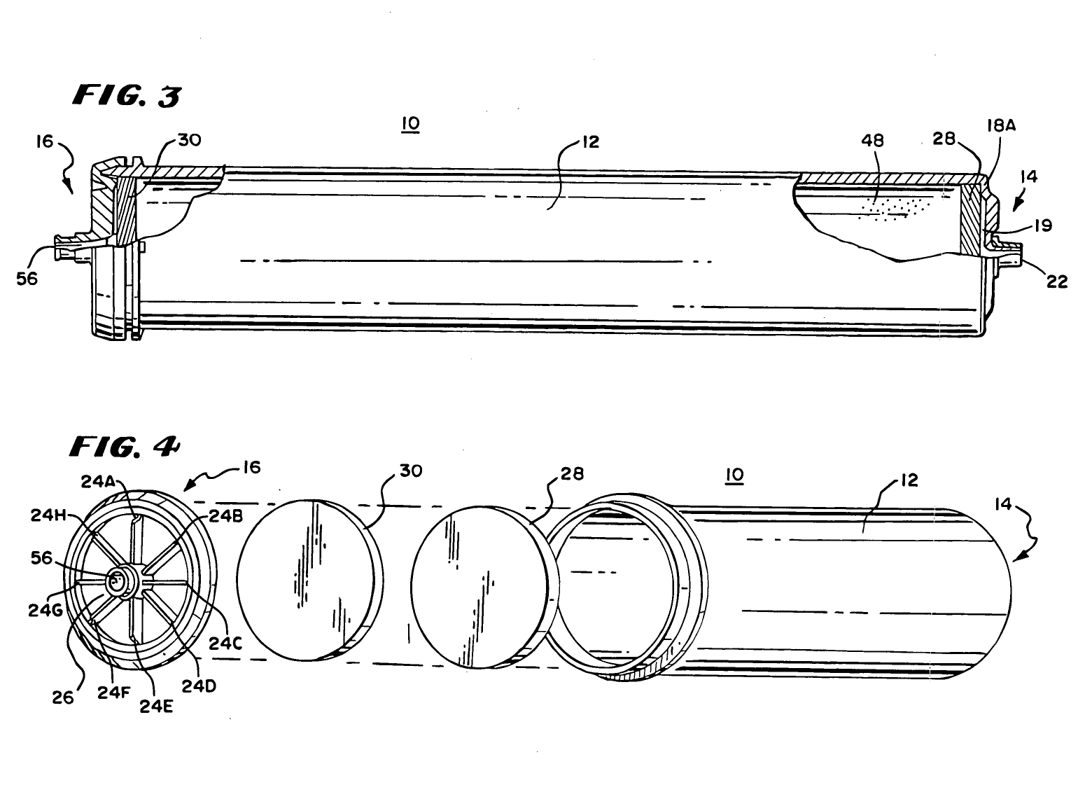

In FIGS. 3 and 4, there are shown a side elevational view and a perspective exploded view respectively of an embodiment of column 10 having a column body 12, an inlet end 16 and an outlet end 14 with the direction of flow of fluid being from the inlet end 16 through packing material 48 in the tubular column body 12 and out of the outlet end 14 in that order. In this embodiment, the inlet end 16 has a spin welded seal. However any suitable column may be used such as the embodiments described in any of the related cases described above and particularly in U.S. application Ser. No. 11/171,698, the disclosure of which is incorporated herein by reference. In the embodiments of FIGS. 3 and 4, the outlet end 14 includes radially extending channels 18A-18H (only 18A being shown in FIG. 3) a base plate or end plate 19 and an outlet port 22 (FIG. 3). The inlet end 16 includes radially extending channels 24A-24H, a base plate or end plate 26 and an inlet port 56. The tubular body 12 has a side wall portion designed to be either integrally molded with one of the ends or to be connected by welding such as by spin welding to the ends. The outlet port 22 includes a female luer connection partly threaded to connect to a source of fluid through a connector, which in some embodiments may be spring-biased and extends as a hollow cylindrical tube through the center of the base plate 19 where it communicates with the outlet channels 18A-18H.

To permit efficient spin welding of a seal on the inlet end 16, the end plate 26 includes radially extending ridges that permit gripping by conventional spin welding equipment to spin the end plate for the purpose of a spin weld. The spin welded seal is intended to maintain its seal under larger forces such as would occur because of higher pressure in the column during use of a larger sized column. Appropriate spin welding equipment can be obtained from any of several sources such as Dukane Corporation, 2900 Dukane Drive, St. Charles, Ill. or Trinetics Group Inc., 1885 Armstrong Drive, Titusville, Fla.

The packing material 48 is spherical or spheroid-like silica granules that have been derivatized to improve their adsorption desorption characteristics. In the preferred embodiment, they include alkyl chains which may have other groups connected to them to cause them to be less polar and thus provide reversed phase chromatography. The use of spherical and spheroid-like silica granules reduces pressure to permit the use of ligands suitable for separation normally requiring HPLC with flash chromatographic columns. Spherical and spheroid-like silica has been available for use in HPLC. In this specification, the terms “spherical and spheroid-like” when applied to granules or particles or packing such as silica granules or particles or packing means granules or particles or packing that are curvilinear and spherical or instead of being spherical are slightly misshapen such as into an ellipsoid but also include such particles, granules and packing that may not fit the mathematical definition of an ellipsoid but are nonetheless curved such as a sphere that has been squashed slightly. They will always be within the general proportions of a sphere or an ellipsoid within twenty-five percent and will be substantially devoid of any sharp or rough edges more characteristic of irregular silica particles, granules or packing. The processes for attaching ligands including the non-polar ligands mentioned above in equations 1, 2 and 3 are taught in many numerous prior art references such as for example, U.S. Pat. Nos. 5,874,603 and 6,800,777.

In the preferred embodiment, the outlet end 14 includes a plurality of radially extending outlet channels 18A-18H, a base plate or end portion 19 and an outlet port 22, and the inlet end 16 includes a plurality of radially extending inlet channels 24A-24H, a base plate or end portion 26 and an inlet port 56. The column body 12 has a side wall portion integrally molded with a first end (outlet end 14) and has a second molded open end (inlet end 16) with outlet and inlet ports 22 and 56 molded in the respective end members.

In FIG. 5, there is shown a chromatographic system 70 having a source of chromatographic fluid under pressure 72, a source of sample, sample injector and disposable column with welded end and retaining plate 74 and a collection and/or analyzing section 76. The source of chromatographic fluid under pressure 72 supplies fluid to the disposable column 74 through a connection held in place by spring pressure so as not to require threaded connectors that must be tightened or loosened with tools such as wrenches. Sample is injected into the column for analysis and/or collection in the collection and/or analysis section 76. In the preferred embodiment, the disposable column with welded end 74 is designed for high flow through rates and short elution times. In some embodiments, one or more retaining plates are used to hold the packing in place or to apply pressure to the packing, particularly with high pressures. In some embodiments, one or more retaining plates are used to provide additional support to the support otherwise provided by an end plate of the column. The retaining plate is flexible and linearly pressed into position to permit automatic assembly. The column is intended for one run after which a new column is used although it may last through several runs.

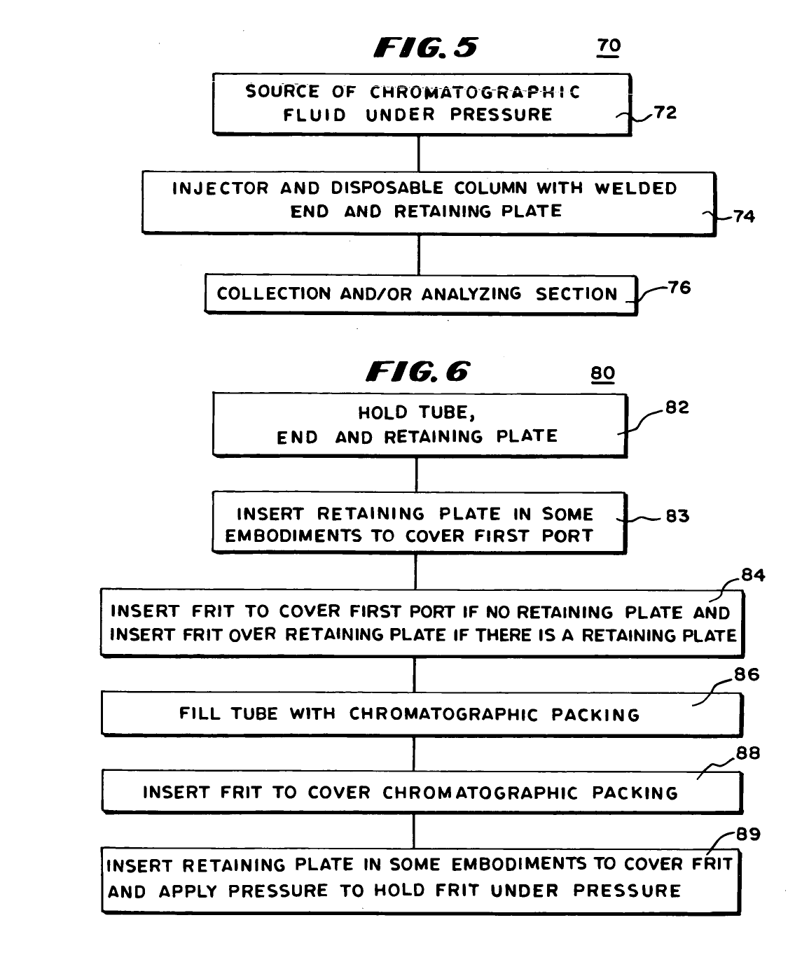

In FIG. 6, there is shown a block diagram of a process 80 for forming the column used in the chromatographic system of FIG. 5. As shown in step 82 of this figure, three separate units are molded. They are: (1) the tubular column body 12 of the chromatographic column 10; (2) in most embodiments, at least one retaining plate; and (3) column ends. A plurality of retaining plates may be spaced throughout the column. After the body of the column has been molded in those high pressure embodiments requiring a retaining plate, a frit plug or a retaining plate and a frit plug are inserted into the column so that the retaining plate, if one is included, is against the port and the frit plug against the packing as shown in step 83. Because the outer diameter of the retaining plate is slightly larger than the inner diameter of the walls of the column, the retaining plate is pushed inwardly under compression by the walls of the column against the edge of the retaining plate. The walls exert force against the edge of the retaining plate toward the center of the retaining plate as the retaining plate is pressed into the tubular column body. This bends the resilient plate so that it exerts force against the packing even if there is some shrinkage in the packing as long as the shrinkage or play on the other side does not exceed the resilience of the plate. The plate permits the closure to be welded while the packing is maintained under pressure rather than attempting to use the spin welding equipment to pressurize the packing.

For this effect, the retaining plate is flexible and sized in some embodiments to grip the inner walls of the tubular body tightly to form a seal against the walls as it is linearly pressed into the tubular body sufficient to grip the inner walls of the tubular body with sufficient force to permit placing the packing under pressure and holding the pressure. For this purpose, it should have an effective modulus of elasticity sufficiently low to flex as it is pressed into the column by an amount greater than the increase in inner diameter of the column as the column moves outwardly under high pressure and sufficiently high to grip the walls of the column with enough force to not be moved into a position that permits the packing to become loosened and create gaps or discontinuities. The rupture strength and yield point of the material from which the retaining plate is made must be sufficient to withstand the bending as it is pressed into the column. In this specification, the term “effective modulus of elasticity” means the ratio of stress to strain of the entire retaining plate rather than of the material from which it is composed so that it reflects the distance the retaining plate flexes inwardly under force as it is pressed into the column.

If the embodiment is one requiring a retaining plate, a filter or frit plug is next inserted into the tubular body to rest against the retaining plate, or if no retaining plate is required, to rest against the port and the open end of the channels molded into the end plate as shown in step 84. The filter and retaining plate, if one is included, are disk-shaped in the preferred embodiment to conform to the shape of the inner walls of the column. The filter and retaining plate, if a retaining plate is included, lie against the channels molded in the inlet and outlet that channel fluid outwardly from the inlet port inwardly to the outlet port to more uniformly collect the solvent flowing out of the packing material from across its cross section. The packing material is generally in the form of beads or other particles that may be inserted and packed in place.

When the filter and retaining plate, if a retaining plate is included, are in place, the tube is filled to the extent desired with chromatographic packing material as shown in step 86. The packing material is packed uniformly. In the preferred embodiment, this is accomplished by agitating the filled column and adding packing material if the settled packing material originally inserted falls below the required volume. The column is vibrated to aid in settling the packing material. After being filled to the extent desired with uniform packing material, a second disk-shaped flat filter is placed to hold the packing material in place.

In some embodiments, the column is vibrated during packing to press the packing down. In the case of spherical and spheroid-like particles, dry vibratory packing may be used for derivitized particles smaller than 50 microns. If the particles were not spherical or spheroid-like, wet packing would be required for some particles under 50 microns. In some embodiments, particles under 50 microns and preferably 40 microns or less would be inserted in the column, the column vibrated to pack the particles and more packing added. This process is repeated until the column is packed. In this specification, the words, “packing in stages” means compressing the bed by vibrating between steps of adding derivitized spherical or spheroid-like silica particles having diameters less than 50 microns.

In embodiments in which the outlet end of the column is molded integrally with the tubular body, the process is similar except the inlet plate rather than the outlet plate is molded as a separate entity and a retaining plate is pressed into place after the packing material has been compressed and the frit plug located over the packing material so that the retaining plate rests over the inlet channels. While in the preferred embodiment, the retaining plate or plates are located next to the end plate or plates and the frit plug or frit plugs are located next to the packing material, the retaining plates can be located next to the packing material if it contains only small openings so as to be able to compress the packing material and hold the silica particles comprising the packing material in place. If the retaining plates are next to the packing material, then the frit plug is located next to the outlet channels. In some embodiments, only a retaining plate is needed.

After the packing is in place, the frit plug is located over the packing as shown in step 88 and a second retaining plate may be inserted as shown in step 89. The second retaining plate is held in place by its edges in the same manner as the first retaining plate and maintains pressure against the packing to maintain a tightly packed column with a minimum of discontinuities that could cause band spreading. Thus a single retaining plate may be used to press the packing against an integrally formed end of the column or retaining plates may be used on each end or multiple retaining plates may be used one next to the other to provide resistance to movement of the packing material.

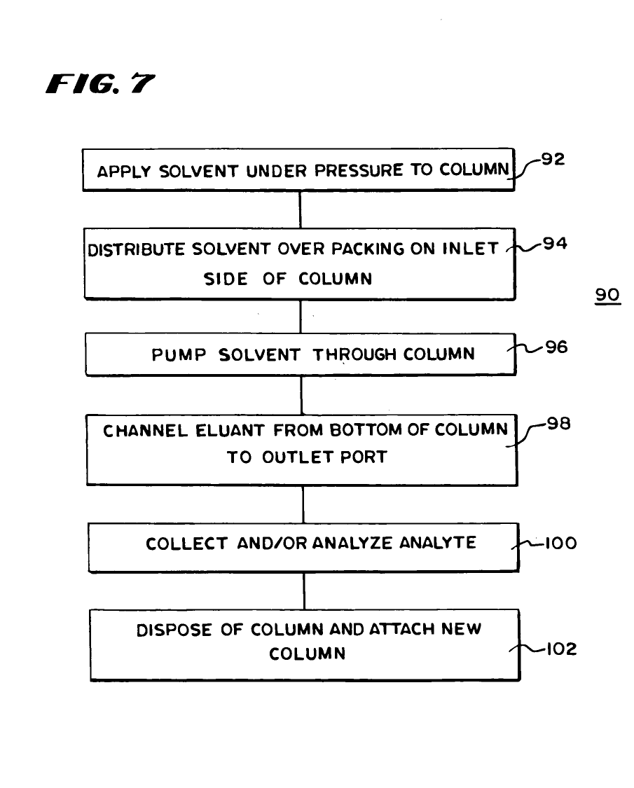

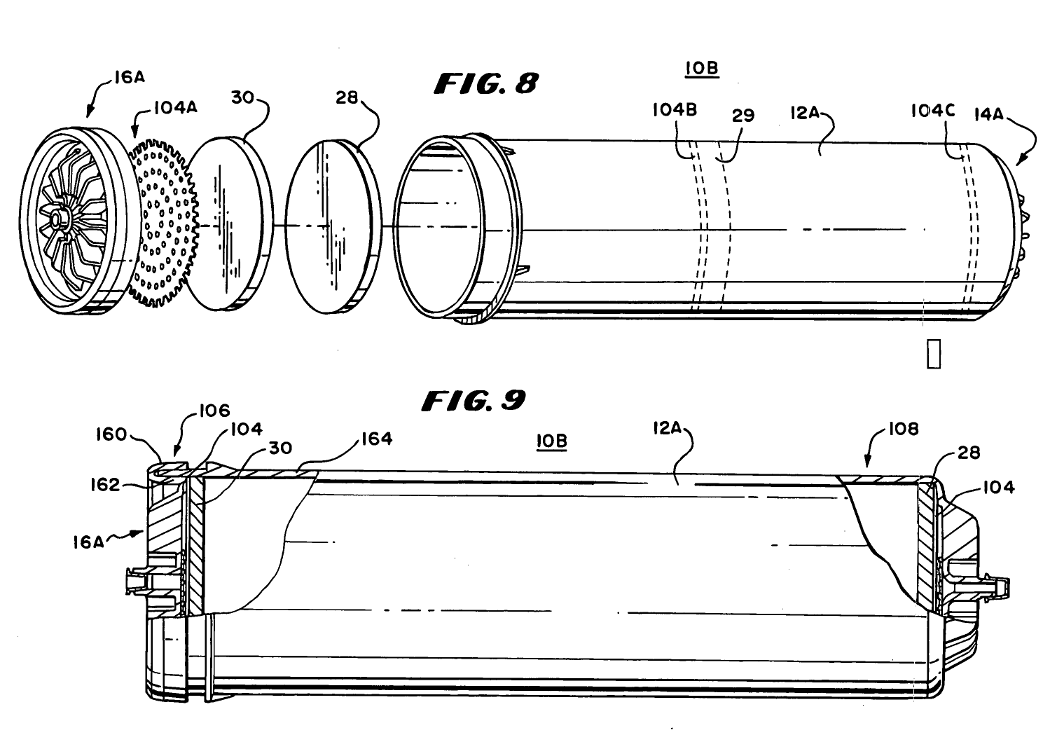

In FIG. 7, there is shown a flow diagram 90 of a process of chromatography utilizing the column 10 of FIGS. 3 and 4 or column 10B of FIGS. 8 and 9. As shown in FIG. 7, the column when assembled as described in connection with FIGS. 3, 4, 8 and 9 has solvent applied under pressure as shown at step 92. The solvent is distributed over the inlet end of the packing material by channels through which it flows and which have the side facing the packing material open so that the fluid pressure flows the liquid across the filter and then from the filter down into the packing material as shown at step 94.

The solvent is pumped through the column at the selected flow rate for the chromatographic run as shown at step 96 and carries eluant to the bottom of the column where channels opening against the filter or retaining plate channel the fluid evenly to the outlet port so that fluid with a direct flow route through the packing material is flowed rapidly through the channels to the outlet port rather than through the slower radial path of the packing material as shown in step 98. The eluant is then collected and analyzed in a conventional manner as shown at 100. After a number of runs of between one and ten, but preferably one run, the column is removed and disposed of as shown at step 102. They are constructed economically to render this possible. A new disposable column may then be connected for further chromatographic runs as also shown at step 102. Typically, runs with the disposable columns are completed in 30 minutes or less and should be completed in 60 minutes or less. Flow rates are typically 100 milliliters per minute or less and should be in the range of between 25 ml. and 200 ml. per minute.

It has been found that spherical and spheroid-like particles increase the loading capacity. The sample load that can be loaded on the spherical and spheroid-like packing is approximately twice the size as the sample that can be loaded on the irregular silica particles of the same particle size. The spherical and spheroid-like particles show a reduced loss of resolution by peak width as loading was increased as compared to the irregular C18 packing of a similar particle size. While smaller irregular particle size gives a better plate count than the larger irregular particle size, the spherical particles provide a disproportionate improvement compared to irregular particles of the same size. The back pressure of columns packed with the spherical and spheroid-like particles is much better than the columns packed with irregular particles of a size similar to the size of the spherical and spheroid-like particles.

In FIG. 8, there is shown an exploded view of another embodiment of column 10B similar to the embodiments of column 10 of FIGS. 3 and 4. The embodiment of column 10B is substantially the same as the embodiment of column 10 except that the embodiment 10B includes a retaining plates 104A, 104B and 104C as well as an end cap 16A, a filter 30, the frit plugs 28 and 29, packing material (not shown), a housing 12A and an end cap 14A. As shown in FIG. 8, the retaining plates 104A, 104B and 104C each include a plurality of small teeth extending radially outwardly from the periphery, which dig into the inner wall of the column and hold the retaining plates in place. This serves two purposes. One purpose is to permit the packing material to be pressurized during fabrication of the column before spin welding the end of the column in place and to hold its pressure after fabrication and during chromatographic runs. With this arrangement, under high pressure, such as for example 50 psi or about 600 pounds of force against the end cap for some large diameter configurations, the retaining plates 104A, 104B and 104C aid in holding the frit plugs to compress the packing against becoming loose. Moreover with more tightly packed packing, the frit plug is less likely to be separated and leave gaps in the packing.

In some embodiments of columns, the retaining plates are held by friction against the sides of the inner walls of the housing 12A. It is sufficiently flexible to be pressed in place with linear motion, thus enabling the embodiment of FIG. 8 to be assembled automatically. In practice, it is usually a thin non-elastomeric member. The retaining plates have sufficient open spaces, are formed of a sufficiently flexible material, are sufficiently thin and have a diameter sized so that the retaining plates bend when pressed into place, and when in place, grips the walls of the column. They are pressed into place with sufficient force to prevent packing from moving significantly from its original packed position during a high pressure chromatographic run and thus avoids creating gaps that degrade the performance of the column. In one embodiment, the open spaces are sufficiently small to block packing material.

In this specification, the term “column adjusted retaining plate” means a member sufficiently flexible and sized to grip the inner walls of a column to hold at least one side surface of the packing, or one frit plug, or filter, or porous plate or other member in place against pressure internal to the packing. The pressure internal to the packing in this definition is sufficient to prevent packing from moving from its original packed position during a high pressure chromatographic run and thus sufficiently high to avoid the creation of gaps that degrade the performance of the column.

Packing material in a column that is under sufficient pressure to avoid moving from its original packed position during a high pressure chromatographic run within the design pressure of the column to such an extent as to degrade the performance of the column may be referred to as design-pressure packing in this specification. To fasten the closure by spin welding, the closure is gripped by the spin welding apparatus and spun until the closure is in intimate relationship with the column adjusted retaining plate and a temperature between the closure and the column body has become high enough by friction to weld the closure to the column body. In the preferred embodiment, the intimate contact is touching but could be slightly short of touching or the spin welding apparatus could touch and press inwardly to add to the pressure applied to the packing. These relationships are each referred to as intimate relationships.

A column adjusted retaining plate has a high enough modulus of elasticity to hold design-pressure packing in place. When the design-pressure packing is in place, the walls of the column are bowed outwardly from the hoop force caused by the design-pressure packing but the column adjusted retaining place is flexed enough to hold the packing with an interference fit or by digging into the walls of the column or by another mechanism to hold the packing in place. It has a modulus of elasticity sufficiently low to permit it to be pressed into place with linear force and has dead space sufficiently small to avoid degrading of the chromatographic peaks.

A retaining plate that is column adjusted, has a modulus of elasticity sufficiently high to hold the packing in place, has dead space sufficiently low to avoid degrading of the chromatographic peaks and can be pressed into place with a linear force sufficiently high to pressurize the packing. Retaining plates having these characteristics will from time to time be referred to herein as chromatographically-adjusted retaining plates. Dead space is the space in openings in the retaining plate that may hold eluant. It is reduced by making the openings small and the thickness of the retaining plate low while having sufficient openings to provide flexibility. In the preferred embodiment, it is a thin stainless steel plate with many small holes in it and peripheral, radially-extending, spaced apart teeth to dig into the inner wall of the column as described hereinafter.

In FIG. 9, there is shown a side elevational view of the column 10B with the housing 12A partly broken away at 106 and 108 respectively to show the frit plugs 30 and 28 as well as the retaining plates 104A and 104C at the inlet and outlet ends of the column. Otherwise the column is as described in connection with FIG. 8. As shown in this view, the spin-welded inlet end 16A is formed with a circumferential loop having sides 160 and 162 that receive the end of wall 164 of the column 10B to which the loop is friction welded by rapid spinning. Retaining plates 104A and 104C are located against the open sides of the channels on each side in the embodiment of FIG. 9, but in other embodiments, the retaining plate can be located at a distance from the ends of the columns or only on the end of the column that is open to receive the independently molded end plate so that it can be pressed against the packing to hold it in place under pressure.

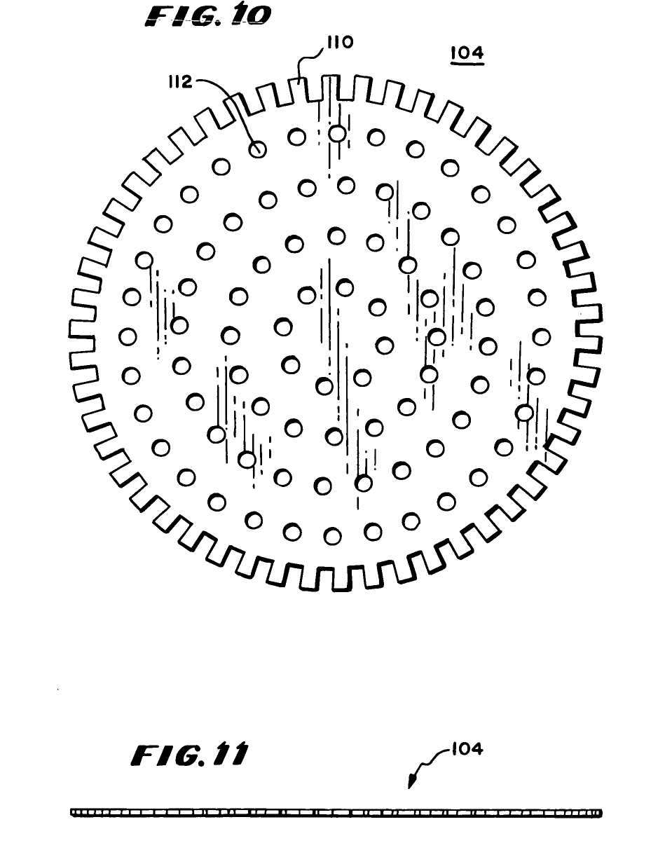

In FIGS. 10 and 11, there are shown a plan view and a side view respectively of retaining plate 104. As best shown in FIG. 10, the retaining plate 104 has a plurality of teeth 110 surrounding its periphery and a plurality of openings 112 in its central portion. The openings 112 are sufficiently large to permit unimpeded flow of eluant and solvent. In a preferred embodiment, they have diameters of 0.125 of an inch and should be in a range of between 50 thousandth and three tenths of an inch. The teeth 110 are separated one from the other by the same distance as the diameter of the openings 112 and have widths similar to the diameter of the openings in the preferred embodiment. As best shown in FIG. 11, the retaining plate 104 is sufficiently thin to permit bending, particularly at the teeth 110, and gripping of the internal walls of the column when perpendicular to the longitudinal axis of the column. It is located between the end plate and the frit plug so as to resist the force of fluid. It may be made of any suitable material compatible with the fluids flowing through the column having sufficient rupture strength, a high enough yield point and sufficient modulus of elasticity. In the preferred embodiment, the retaining plate 104 is stainless steel and has a thickness of 31 thousandth of an inch.

From the above description, it can be understood that the method and apparatus of this invention has several advantages, such as: (1) it is economical in terms of its fabricating materials; (2) it is inexpensive to assemble; (3) it can be assembled readily in an automated process; and (4) it can be easily formed of relatively inexpensive materials.

While a preferred embodiment of the invention has been described with some particularity, many modifications and variations in the invention are possible within the light of the above teaching. Therefore, it is to be understood, that within the scope of the pending claims, the invention may be practiced other than as specifically described.

What is claimed is:

1. Chromatographic packing comprising:
at least one of spherical and spheroid-like silica particles with ligands grafted onto their surface;
said at least one of spherical and spheroid-like silica particles having diameters of between 10 and 50 microns.

2. Chromatographic packing in accordance with claim 1 having a surface that alters adsorb-desorb characteristics of the at least one of spherical and spheroid-like particles to provide reduced back pressure due to size and shape of the particles that offsets increased back pressure sufficiently caused by the ligands so that flash chromatography can be used for separations that would otherwise require HPLC.

3. Chromatographic packing in accordance with claim 2 wherein the diameters of the particles fall within 20 and 40 microns.

4. Chromatographic packing in accordance with claim 3 wherein the ligands have low polar characteristics to permit reversed phase chromatography.

5. Chromatographic packing in accordance with claim 4 wherein at least one of the ligands is n-Octyl-trimethoxysilane.

6. Chromatographic packing in accordance with claim 4 wherein at least one of the ligands is n-Octadecyl-trimethoxysilane.

7. Chromatographic packing in accordance with claim 4 wherein at least one of the ligands is n-Octadecyl-dimethylmethoxysilane.

8. A method of making packing comprising the steps of reacting a molecule with a desired adsorption-desorption characteristic with silica spheres and spheroid-like particles to form a bond connecting the ligand.

9. A method in accordance with claim 8 wherein the step of forming a bond includes the step of forming a silane bond.

10. A chromatographic column comprising:
a tubular body portion;
a first end having an integrally formed first port;
a second end having an integrally formed second port;
packing within said tubular body portion;
said packing including at least one of derivitized spherical and derivitized spheroid-like silica granules.

11. A chromatographic column in accordance with claim 10 including at least one column adjusted retaining plate within the tubular body portion between the first end and the second end.

12. A chromatographic column in accordance with claim 10 wherein the column includes design-pressure packing.

13. A chromatographic column in accordance with claim 10 in which the retaining plate has an effective modulus of elasticity.

14. In a chromatographic column having a tubular body portion containing packing material; an inlet port and an outlet port, a combination of said tubular body portion and packing material that includes at least one of derivitized spherical and spheroid-like granules.

15. The combination of claim 14 further including first and second column adjusted retaining plates with the packing material being pressed between at least the first column adjusted retaining plate and the second column adjusted retaining plate to prevent formation of discontinuities as solvent flows through the chromatographic column.

16. A method of manufacturing a chromatographic column comprising the steps of:
molding a column body from plastics;
adding packing material to the column;
the step of adding packing material to the column including the step of filling the column body with spherical or spheroid-like derivitized granules; and
connecting at least one column end to the column body.

17. A method in accordance with claim 16 further including the step of inserting at least one column adjusted retaining plate during the assembly of the column before a closure is fastened to the column body prior to connecting a last to be connected of column ends.

18. A method in accordance with claim 16 further including the steps of:
pressing into the tubular column body at least one column adjusted retaining plate before closing the column to compress the spherical or spheroid-like derivitized granules wherein packing and retaining plates are selected to increase a pressure rating of a flash chromatographic column and thus permit a wider range of materials to be separated by flash chromatography; and
applying pressure to the at least one column adjusted retaining plate during assembly of the column sufficient to form a design-pressure packing.

19. A method in accordance with claim 17 in which the step of inserting at least one column adjusted retaining plate includes the steps of inserting a column adjusted retaining plate after packing material has been added and pressing the retaining plate inwardly to exert force on the packing material.

20. The method of claim 17 wherein the step of fastening the closure includes the step of spin welding a closure to the side wall portion of the column.

21. A method in accordance with claim 17 including the step of increasing the pressure rating of the column by adding column adjusted retaining plates.

22. The method of claim 17 further including the step of disposing of the column after between one and ten chromatographic runs and connecting a new column.

23. The method of claim 16 wherein the step of adding packing material includes the step of dry packing.

24. The method of claim 16 wherein the step of dry packing includes the step of vibrating the packing.

25. The method of claim 24 wherein the step of dry packing includes the step of staged dry packing.

26. A method of separating components of a mixture containing at least a first and second component, comprising the steps of:
applying the mixture having at least a first and second component to a reactor containing packing formed of derivatized spherical and spheroid-like silica wherein the derivitized spherical and spheroid-like silica includes material having a different attraction for at least one of the components than another of the components in the mixture having at least a first and second component;
pumping liquid phase through the packing at a pressure of between 0 psi and 200 psi wherein a flow rate is in a range of between 5 and 200 milliliters.

27. A method of reverse phase flash liquid chromatography, comprising the steps of:
applying sample to a flash chromatographic column containing packing formed of derivatized spherical and spheroid-like silica wherein the derivitized spherical and spheroid-like silica includes non-polar alkyl chains;
pumping liquid phase through the packing at a pressure of between 0 and 400 psi wherein a flow rate is in a range of between 5 and 200 milliliters.

28. A method of reducing the pressure at which a chromatographic separation is performed comprising the steps of:
selecting a more uniform size packing particle;
filling the column with closely packed shaped stabilized particles; and
derivitizing the shape stabilized particles to improve resolution of the desired material.

29. A method of improving the capacity and resolution of liquid chromatography in separating components of a mixture containing at least a first and second component, comprising the steps of:
preparing a column of the same size as columns that have been used in liquid chromatography packed with irregular-shaped silica particles derivitized to be C18 packing;
substituting C18 packing with the same size silica particles as the irregular-shaped silica particles having a spherical or spheroid-like shape for the irregular shaped silica particles, wherein approximately twice as much mixture may be injected into a same size column;
applying the mixture having at least a first and second component to the column wherein derivitized spherical and spheroid-like silica includes material having a different attraction for at least one of the components than another of the components in the mixture having at least a first and second component; and
pumping liquid phase through the C18 packing at a pressure of between 0 psi and 200 psi wherein a flow rate is in a range of between 5 and 200 milliliters.
